(19) United States
(12) Patent Application Publication
(10) Pub. No.: US 2016/0175648 A1
(43) Pub. Date: Jun. 23, 2016

(54) EXERCISE ANALYSIS DEVICE, EXERCISE ANALYSIS SYSTEM, EXERCISE ANALYSIS METHOD, DISPLAY DEVICE, AND RECORDING MEDIUM

(71) Applicant: SEIKO EPSON CORPORATION, Tokyo (JP)

(72) Inventor: Kenya KODAIRA, Azumino-shi (JP)

(73) Assignee: SEIKO EPSON CORPORATION, Tokyo (JP)

(21) Appl. No.: 14/964,013

(22) Filed: Dec. 9, 2015

(30) Foreign Application Priority Data
Dec. 22, 2014 (JP) 2014-258534

(51) Int. Cl. A63B 24/00; G01P 3/00; G01P 13/02; G01P 15/02

(52) U.S. Cl. CPC A63B 24/0006; G01P 15/02; G01P 3/00; G01P 13/02

(57) ABSTRACT

An exercise analysis device includes a calculator that obtains a change in a relation between a movement direction of a hitting surface of an exercise tool and a posture of the hitting surface during an exercise by using an output of an inertial sensor.

### BACKGROUND

1. Technical Field

The present invention relates to an exercise analysis device, an exercise analysis system, an exercise analysis method, a display device, and a recording medium.

2. Related Art

In golf swings, there are several checkpoints such as halfway back, top, and halfway down during a period from address to impact. For golfers to aim at ideal swings, to take good postures at the checkpoints is a shortcut.

In the related art, it is effective to photograph swing motions to check golf swings. For example, JP-A-2002-210055 discloses a technology for displaying a swing trajectory based on a swing video and displaying the speeds of swings in a polygonal form.

However, information regarding speeds may be effective for estimating hitting speeds, but it is not sufficient to evaluate goodness or badness of swings.

### SUMMARY

An advantage of some aspects of the invention is that it provides an exercise analysis device, an exercise analysis system, an exercise analysis method, and a program capable of acquiring effective information in swing evaluation.

The invention can be implemented as the following forms or application examples.

### APPLICATION EXAMPLE 1

An exercise analysis device according to this application example includes a calculator that obtains a change in a relation between a movement direction of a hitting surface of an exercise tool and a posture of the hitting surface during an exercise by using an output of an inertial sensor. This relation is considered to have a strong influence on a projectile path. Accordingly, in the exercise analysis device according to this application example, it is possible to obtain effective information in evaluation of a swing.

### APPLICATION EXAMPLE 2

In the exercise analysis device according to the application example, the calculator may obtain an angle formed by a vector indicating a movement direction of the hitting surface and a predetermined vector along the hitting surface as the relation. Accordingly, it is possible to accurately measure the relation.

### APPLICATION EXAMPLE 3

In the exercise analysis device according to the application example, the calculator may obtain an angle formed by a vector indicating a movement direction of the hitting surface and a predetermined vector intersecting the hitting surface as the relation. Accordingly, it is possible to accurately measure the relation.

### APPLICATION EXAMPLE 4

The exercise analysis device according to the application example may further include an output processor that outputs the change in the relation. Accordingly, the user can recognize the relation.

### APPLICATION EXAMPLE 5

In the exercise analysis device according to the application example, the output processor may display the change in the relation as a change in color.

### APPLICATION EXAMPLE 6

In the exercise analysis device according to the application example, the output processor may assign and display color decided in advance for each range to which the relation belongs.

### APPLICATION EXAMPLE 7

In the exercise analysis device according to the application example, the output processor may display the change in the relation along with trajectory information regarding the exercise tool during the exercise.

### APPLICATION EXAMPLE 8

In the exercise analysis device according to the application example, the output processor may output a timing at which the relation falls in a predetermined range.

### APPLICATION EXAMPLE 9

An exercise analysis system according to this application example includes the exercise analysis device according to the application example; and an inertial sensor. This relation is considered to have a strong influence on a projectile path. Accordingly, in the exercise analysis system according to this application example, it is possible to obtain effective information in evaluation of a swing.

### APPLICATION EXAMPLE 10

An exercise analysis method according to this application example includes obtaining a change in a relation between a movement direction of a hitting surface of an exercise tool and a posture of the hitting surface during an exercise by using an output of an inertial sensor. This relation is considered to have a strong influence on a projectile path. Accordingly, in the exercise analysis method according to this application example, it is possible to obtain effective information in evaluation of a swing.

### APPLICATION EXAMPLE 11

A display device according to this application example displays a change in a relation between a movement direction of a hitting surface of an exercise tool and a posture of the hitting surface during an exercise by using an output of an inertial sensor.

Accordingly, the user can understand a change in the square degree in a swing.

### APPLICATION EXAMPLE 12

In the display device according to the application example, the change may be displayed with a gray scale.

Accordingly, the user can intuitively understand a change in the square degree in a swing.

### APPLICATION EXAMPLE 13

A recording medium according to this application example records an exercise analysis program causing a computer to perform obtaining a change in a relation between a movement direction of a hitting surface of an exercise tool and a posture of the hitting surface during an exercise by using an output of an inertial sensor. This relation is considered to have a strong influence on a projectile path. Accordingly, in the recording medium according to this application example, it is possible to obtain effective information in evaluation of a swing.

### BRIEF DESCRIPTION OF THE DRAWINGS

The invention will be described with reference to the accompanying drawings, wherein like numbers reference like elements.

FIG. 1 is a diagram illustrating the overview of a swing analysis system as an example of an exercise analysis system according to an embodiment.

FIG. 2 is a diagram illustrating an example of a position and a direction in which a sensor unit is mounted.

FIG. 3 is a diagram illustrating a procedure of a motion performed by a user according to the embodiment.

FIG. 4 is a diagram illustrating an example of the configuration of the swing analysis system according to the embodiment.

FIG. 5 is a diagram illustrating a relation between a golf club and a global coordinate system Σ_{XYZ} in address.

FIG. 6 is a flowchart illustrating an example of the procedure of a swing analysis process according to the embodiment.

FIG. 7 is a flowchart illustrating an example of the procedure of a first motion detection process.

FIG. 8A is a diagram illustrating a graph of a triaxial angular velocity at the time of a swing.

FIG. 8B is a diagram illustrating a graph of a composite value of the triaxial angular velocity.

FIG. 8C is a diagram illustrating a graph of a differential value of the composite value of the triaxial angular velocity.

FIG. 9 is a flowchart illustrating an example of the procedure of a second motion detection process.

FIG. 10 is a flowchart illustrating an example of the procedure of a process of calculating a square degree ξ (step 70 of FIG. 6).

FIG. 11 is a diagram illustrating a face vector in address.

FIG. 12 is a diagram illustrating a face vector and a movement direction vector at time t.

FIG. 13 is a diagram illustrating the square degree ξ.

FIG. 14 is a graph illustrating a time change of the square degree ξ.

FIG. 15 is a diagram illustrating a display example of the square degree ξ.

FIG. 16 is a diagram illustrating another display example of the square degree ξ.

### DESCRIPTION OF EXEMPLARY EMBODIMENTS

Hereinafter, preferred embodiments of the invention will be described in detail with reference to the drawings. Embodiments to be described below do not inappropriately limit content of the invention described in the appended claims. All of the constituent elements to be described below may not be necessarily requisite constituent elements.

Hereinafter, a swing analysis system that analyzes a golf swing will be described as an example of an exercise analysis system.

### 1. Swing Analysis System

### 1-1. Overview of Swing Analysis System

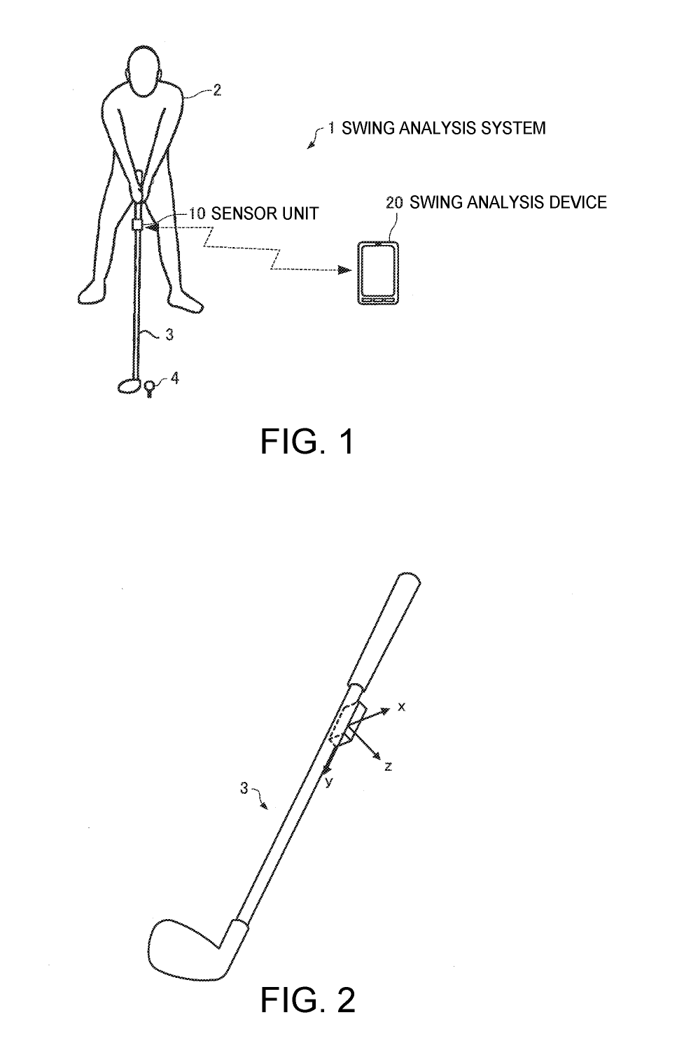

FIG. 1 is a diagram for describing the overview of the swing analysis system according to an embodiment. A swing analysis system 1 according to the embodiment is configured to include a sensor unit 10 (which is an example of an inertial sensor) and a swing analysis device 20 (which is an example of an exercise analysis device).

The sensor unit 10 can measure acceleration generated in each axis direction of three axes and an angular velocity generated around each axis of the three axes and is mounted on a golf club 3 (which is an example of an exercise tool).

In the embodiment, as illustrated in FIG. 2, the sensor unit 10 is fitted on a part of the shaft of the golf club 3 when one axis among three detection axes (the x axis, the y axis, and the z axis), for example, the y axis, conforms with the major axis direction of the shaft. Preferably, the sensor unit 10 is fitted at a position close to a grip in which a shock at the time of hitting is rarely delivered and a centrifugal force is not applied at the time of swing. The shaft is a portion of the grip excluding the head of the golf club 3 and also includes the grip.

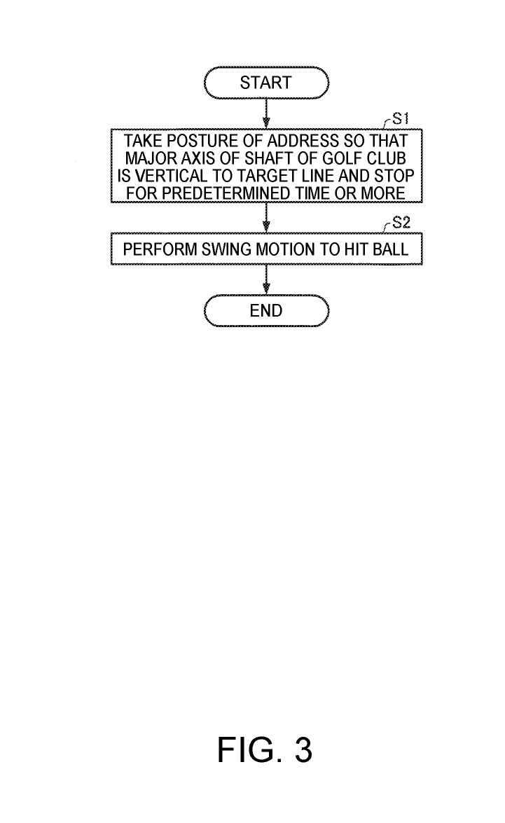

A user 2 performs a swing motion of hitting a golf ball 4 in a pre-decided procedure. FIG. 3 is a diagram illustrating the procedure of a motion performed by the user 2. As illustrated in FIG. 3, the user 2 first holds the golf club 3, takes a posture of address so that the major axis of the shaft of the golf club 3 is vertical to a target line (target direction of hitting), and stops for a predetermined time or more (for example, 1 second or more) (S1). Next, the user 2 performs a swing motion to hit the golf ball 4 (S2).

While the user 2 performs the motion to hit the golf ball 4 in the procedure illustrated in FIG. 3, the sensor unit measures triaxial acceleration and triaxial angular velocity at a predetermined period (for example, 1 ms) and sequentially transmits the measurement data to the swing analysis device 20. The sensor unit 10 may immediately transmit the measurement data, or may store the measurement data in an internal memory and transmit the measurement data at a predetermined timing such as a timing after the end of a swing motion of the user 2. Communication between the sensor unit 10 and the swing analysis device 20 may be wireless communication or wired communication. Alternatively, the sensor unit 10 may store the measurement data in a recording medium such as a memory card which can be detachably mounted and the swing analysis device 20 may read the measurement data from the recording medium.

The swing analysis device 20 according to the embodiment obtains a change in the posture of a face surface (hitting surface) in a swing using data measured by the sensor unit 10. Then, the swing analysis device 20 displays a change in the posture by a difference in color on a displayer (display). The swing analysis device 20 may be, for example, a portable device such as a smartphone or a personal computer (PC).

### 1-2. Configuration of Swing Analysis System

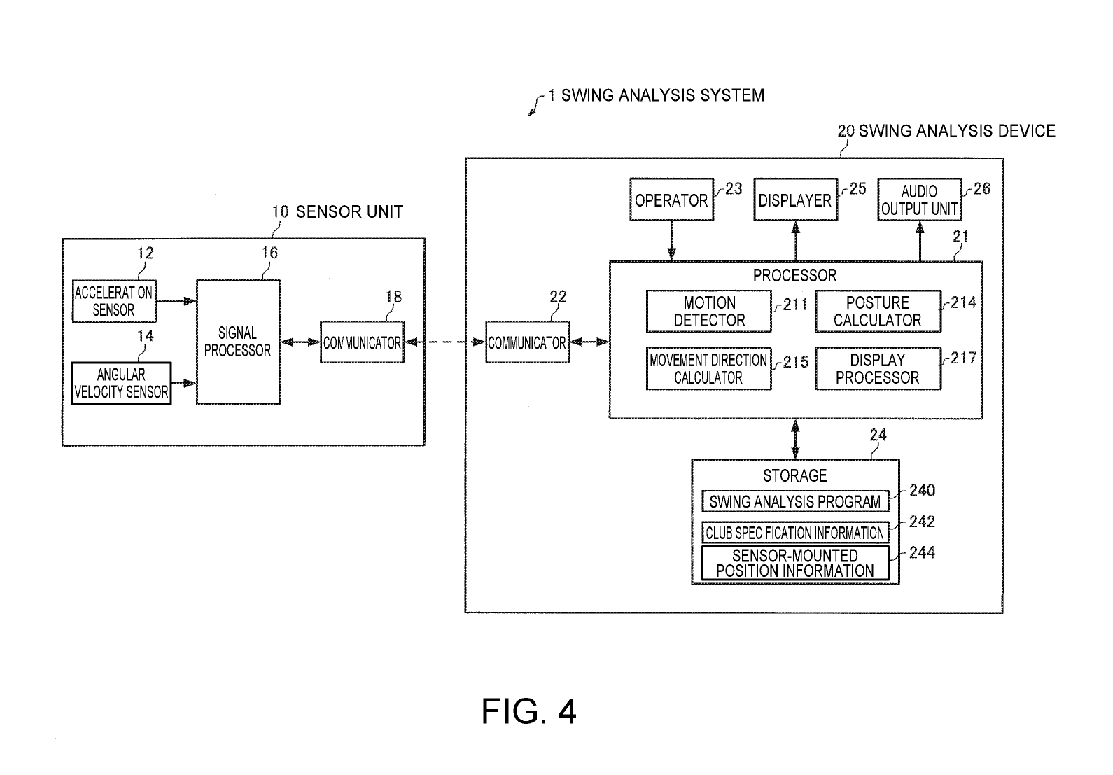

FIG. 4 is a diagram illustrating an example of the configuration of the swing analysis system 1 (examples of the configurations of the sensor unit 10 and the swing analysis device 20) according to the embodiment. As illustrated in FIG. 4, in the embodiment, the sensor unit 10 includes an acceleration sensor 12, an angular velocity sensor 14, a signal processor 16, and a communicator 18.

The acceleration sensor 12 measures acceleration generated in each of mutually intersecting (ideally, orthogonal) triaxial directions and outputs digital signals (acceleration data) according to the sizes and directions of the measured triaxial accelerations.

The angular velocity sensor 14 measures an angular velocity generated around each axis of mutually intersecting (ideally, orthogonal) triaxial directions and outputs digital signals (angular velocity data) according to the sizes and directions of the measured triaxial angular velocities.

The signal processor 16 receives the acceleration data and the angular velocity data from the acceleration sensor 12 and the angular velocity sensor 14, appends time information, and stores the acceleration data and the angular velocity data in a storage (not illustrated). The signal processor 16 generates packet data in conformity to a communication format by appending time information to the stored measurement data (the acceleration data and the angular velocity data) and outputs the packet data to the communicator 18.

The acceleration sensor 12 and the angular velocity sensor 14 are ideally fitted in the sensor unit 10 so that the three axes of each sensor match the three axes (the x axis, the y axis, and the z axis) of the xyz rectangular coordinate system (sensor coordinate system Σ_{xyz}) defined for the sensor unit 10, but errors of the fitting angles actually occur. Accordingly, the signal processor 16 performs a process of converting the acceleration data and the angular velocity data into data of the xyz rectangular coordinate system (sensor coordinate system Σ_{xyz}) using correction parameters calculated in advance according to the errors of the fitting angles.

The signal processor 16 may perform a temperature correction process on the acceleration sensor 12 and the angular velocity sensor 14. Alternatively, a temperature correction function may be embedded in the acceleration sensor 12 and the angular velocity sensor 14.

The acceleration sensor 12 and the angular velocity sensor 14 may output analog signals. In this case, the signal processor 16 may perform A/D conversion on each of an output signal of the acceleration sensor 12 and an output signal of the angular velocity sensor 14, generate measurement data (acceleration data and angular velocity data), and generate packet data for communication using the measurement data.

The communicator 18 performs, for example, a process of transmitting the packet data received from the signal processor 16 to the swing analysis device 20 or a process of receiving control commands from the swing analysis device 20 and transmitting the control commands to the signal processor 16. The signal processor 16 performs various processes according to the control commands.

The swing analysis device 20 includes a processor 21, a communicator 22, an operator 23, a storage 24, a displayer 25, and an audio output unit 26.

The communicator 22 performs, for example, a process of receiving the packet data transmitted from the sensor unit 10 and transmitting the packet data to the processor 21 or a process of transmitting a control command from the processor 21 to the sensor unit 10.

The operator 23 performs a process of acquiring operation data from the user 2 and transmitting the operation data to the processor 21. The operator 23 may be, for example, a touch panel type display, a button, a key, or a microphone.

The storage 24 is configured as, for example, any of various IC memories such as a read-only memory (ROM), a flash ROM, and a random access memory (RAM) or a recording medium such as a hard disk or a memory card.

The storage 24 stores, for example, programs used for the processor 21 to perform various calculation processes or control processes, or various program or data used for the processor 21 to realize application functions. In particular, in the embodiment, the storage 24 stores a swing analysis program 240 which is read by the processor 21 to perform an analysis process for a swing exercise. The swing analysis program 240 may be stored in advance in a nonvolatile recording medium. Alternatively, the swing analysis program 240 may be received from a server via a network by the processor 21 and may be stored in the storage 24.

In the embodiment, the storage 24 stores club specification information 242 indicating the specification of the golf club 3 and sensor-mounted position information 244. For example, the user 2 operates the operator 23 to input a model number of the golf club 3 (or select the model number from a model number list) to be used and set specification information regarding the input model number as the specification information 242 among pieces of specification information for each model number (for example, information regarding the length of a shaft, the position of center of gravity, a lie angle, a face angle, a loft angle, and the like) stored in advance in the storage 24. Alternatively, by mounting the sensor unit 10 at a decided predetermined position (for example, a distance of 20 cm from the grip), information regarding the predetermined position may be stored in advance as the sensor-mounted position information 244.

The storage 24 is used as a work area of the processor 21 and temporarily stores, for example, data input from the operator 23 and calculation results performed according to various programs by the processor 21. The storage 24 may store data necessarily stored for a long time among the data generated through the processes of the processor 21.

The displayer 25 displays a processing result of the processor 21 as text, a graph, a table, animations, or another image. The displayer 25 may be, for example, a CRT, an LCD, a touch panel type display, or a head-mounted display (HMD). The functions of the operator 23 and the displayer 25 may be realized by one touch panel type display.

The audio output unit 26 outputs a processing result of the processor 21 as audio such as a voice or a buzzer sound. The audio output unit 26 may be, for example, a speaker or a buzzer.

The processor 21 performs a process of transmitting a control command to the sensor unit 10, various calculation processes on data received from the sensor unit 10 via the communicator 22, and other various control processes according to various programs. In particular, in the embodiment, the processor 21 performs the swing analysis program 240 to function as a motion detector 211, a posture calculator (which is an example of a calculator) 214, a movement direction calculator 215, a display processor (which is an example of an output processor) 217.

For example, the processor 21 performs operations of receiving the packet data received from the sensor unit 10 by the communicator 22, acquiring time information and measurement data from the received packet data, and storing the time information and the measurement data in the storage 24 in association therewith.

The processor 21 performs, for example, a process of detecting a timing (measurement time of the measurement data) of each motion in a swing of the user 2 using the measurement data.

The processor 21 performs a process of generating time-series data indicating a change in the posture of the sensor unit 10 by applying the angular velocity data included in the measurement data, for example, to a predetermined calculation formula (or the change in the posture is expressed by, for example, rotation angles (a roll angle, a pitch angle, and a yaw angle) of each axis direction, quaternion, a rotation matrix, or the like).

The processor 21 performs a process of generating time-series data indicating a change in the position of the sensor unit 10 by performing, for example, time integration on the acceleration data included in the measurement data (and the change in the position can be expressed by, for example, a speed (speed vector) in each axis direction or the like).

The processor 21 performs a process of generating time-series data indicating a change in the posture of the face surface of the golf club 3 based on, for example, the time-series data indicating the change in the posture of the sensor unit 10, the club specification information 242, and the sensor-mounted position information 244.

The processor 21 performs a process of generating time-series data indicating a change in the position of the face surface of the golf club 3 based on, for example, the time-series data indicating the change in the position of the sensor unit 10, the time-series data indicating the change in the posture of the sensor unit 10, the club specification information 242, and the sensor-mounted position information 244.

Here, the processor 21 according to the embodiment performs, for example, the following steps (1) to (8) to measure the posture of the shaft at each time point, the position of the face surface at each time point, and the posture of the face surface at each time point using the time of the stop of the user 2 (measurement time t₀ of the address) as a criterion.

(1) The processor 21 performs bias correction on the measurement data in the swing by calculating an offset amount included in the measurement data using the measurement data (acceleration data and angular velocity data) at time t₀ and subtracting the offset amount from the measurement data in the swing.

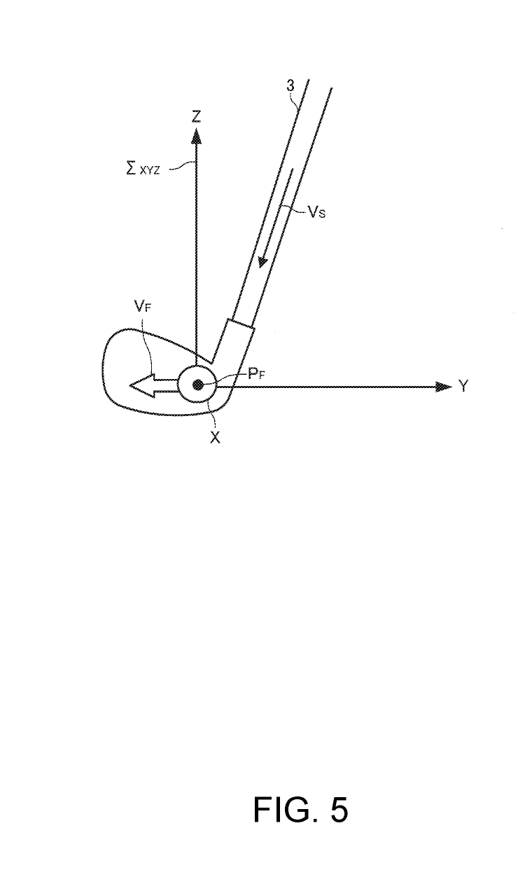

(2) The processor 21 decides the XYZ rectangular coordinate system (global coordinate system Σ_{XYZ}) to be fixed to the ground based on the acceleration data (that is, data indicating the gravity acceleration direction) at time t₀, the club specification information 242, and the sensor-mounted position information 244. For example, as illustrated in FIG. 5, the origin of the global coordinate system Σ_{XYZ} is set to the position of the head at time t₀, the Z axis of the global coordinate system Σ_{XYZ} is set in the vertical upward direction (that is, the opposite direction to the gravity acceleration direction), and the X axis of the global coordinate system Σ_{XYZ} is set in the same direction as the x axis of the sensor coordinate system Σ_{xyz} at time t₀. Accordingly, in this case, the X axis of the global coordinate system Σ_{XYZ} can be regarded as a target line.

(3) The processor 21 decides a shaft vector V_{S} indicating the posture of the golf club 3. Any method of selecting the shaft vector V_{S} can be used. In the embodiment, as illustrated in FIG. 5, a unit vector oriented in the major axis direction of the shaft of the golf club 3 is used as the shaft vector V_{S}.

(4) The processor 21 sets the shaft vector V_{S} at time t₀ in the global coordinate system Σ_{XYZ} as an initial shaft vector V_{S}(t₀) and calculates a shaft vector V_{S}(t) of each time in the global coordinate system Σ_{XYZ} based on the initial shaft vector V_{S}(t₀) and the time-series data (after the bias correction) indicating the change in the posture of the sensor unit 10.

(5) The processor 21 decides a face vector V_{F} indicating the posture of the face surface S_{F}. Any method of selecting the face vector V_{F} can be used. In the embodiment, as illustrated in FIG. 5, a unit vector oriented in the −Y axis direction at time t₀ is used as the face vector V_{F}. In this case, the X axis component and the Z axis component of the face vector V_{F} are 0 at time t₀.

(6) The processor 21 sets the face vector V_{F} at time t₀ in the global coordinate system Σ_{XYZ} as the initial face vector V_{F}(t₀) and calculates the face vector V_{F}(t) at each time in the global coordinate system Σ_{XYZ} based on the initial face vector V_{F}(t₀) and the time-series data (after the bias correction) indicating the change in the posture of the face surface S_{F}.

(7) The processor 21 decides face coordinates P_{F} indicating the position of the face surface S_{F}. Any method of selecting the face coordinates P_{F} can be used. In the embodiment, a point located at the origin of the global coordinate system Σ_{XYZ} at time t₀ is assumed to be the face coordinates P_{F}. In this case, as illustrated in FIG. 5, the X axis component, the Y axis component, and the Z axis component of the face coordinates P_{F} at time t₀ are 0.

(8) The processor 21 sets the face coordinates P_{F} at time t₀ in the global coordinate system Σ_{XYZ} as the initial face coordinates P_{F}(t₀) and calculates the face coordinates P_{F}(t) at each time in the global coordinate system Σ_{XYZ} based on the initial face coordinates P_{F}(t₀) and the time-series data (after the bias correction) indicating the change in the position of the face surface S_{F}.

Here, the bias correction of the measurement data has been performed by the processor 21, but may be performed by the signal processor 16 of the sensor unit 10 or the bias correction function may be embedded in the acceleration sensor 12 and the angular velocity sensor 14.

The processor 21 performs a process of reading/writing various programs or various kinds of data from/on the storage 24. The processor 21 performs not only a process of storing time information and the measurement data received from the communicator 22 in the storage 24 in association therewith but also a process of storing various kinds of calculated information or the like in the storage 24.

The processor 21 performs a process of displaying various images (images, text, signs, and the like corresponding to information such as exercise analysis information (which is an example of a relation between the posture and the movement direction of the face surface) regarding the square degree ξ generated by the processor 21) on the displayer 25. For example, the display processor 217 causes the displayer 25 to display the images, text, or the like corresponding to the exercise analysis information (the information regarding the square degree ξ or the like) generated by the processor 21 after the end of the swing exercise of the user 2, automatically, or according to an input operation of the user 2. Alternatively, a displayer may be provided in the sensor unit 10, and the display processor 217 may transmit image data to the sensor unit 10 via the communicator 22 and cause the displayer of the sensor unit 10 to display various images, text, or the like.

The processor 21 performs a process of causing the audio output unit 26 to output various kinds of audio (including a voice and a buzzer sound). For example, the processor 21 may read various kinds of information stored in the storage 24 and output audio or a voice for analysis of the swing exercise to the audio output unit 26 after the end of the swing exercise of the user 2, automatically, or at the time of performing a predetermined input operation. Alternatively, an audio output unit may be provided in the sensor unit 10, and the processor 21 may transmit various kinds of audio data or voice data to the sensor unit 10 via the communicator 22 and cause the audio output unit of the sensor unit 10 to output various kinds of audio or voices.

A vibration mechanism may be provided in the swing analysis device 20 or the sensor unit 10 and the vibration mechanism may also convert various kinds of information into vibration information and suggest the vibration information to the user 2.

### 1-3. Process of Swing Analysis Device Swing Analysis Process

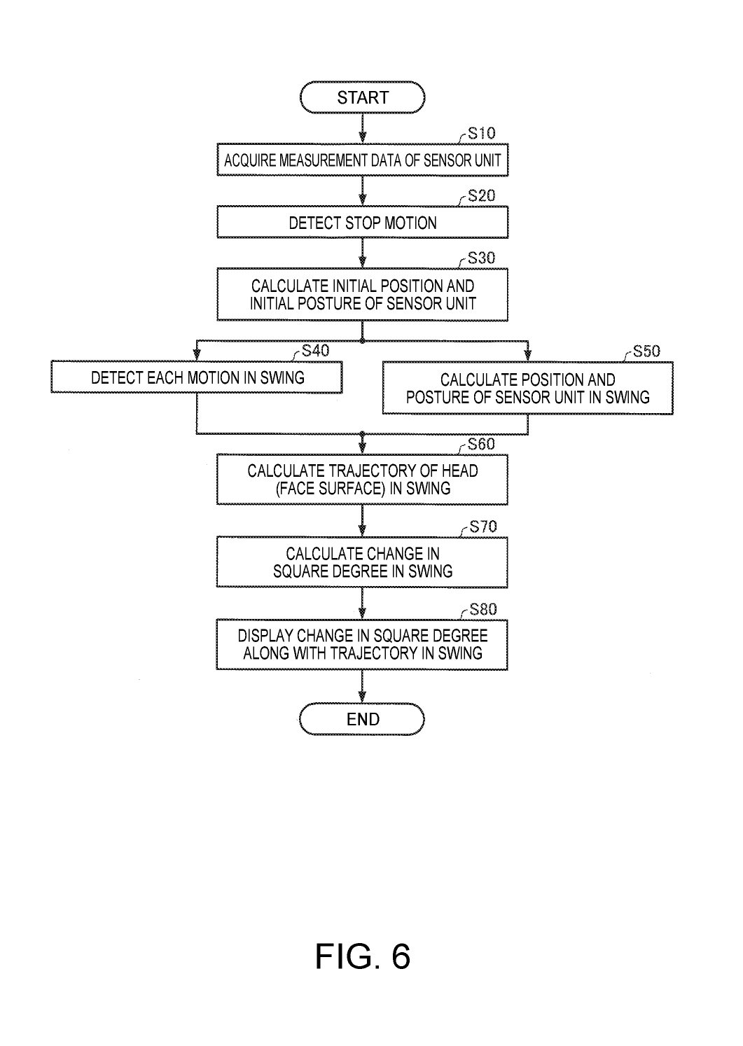

FIG. 6 is a flowchart illustrating the procedure of the swing analysis process for a swing exercise performed by the processor 21 of the swing analysis device 20 according to the embodiment. The processor 21 of the swing analysis device (which is an example of a computer) executes the swing analysis program 240 stored in the storage 24 to perform the swing analysis process of a swing exercise in the procedure of the flowchart of FIG. 6. Hereinafter, the flowchart of FIG. 6 will be described.

First, the processor 21 acquires the measurement data of the sensor unit 10 (S10). In step S10, the processor 21 may perform processes subsequent to step S20 in real time when the processor 21 acquires the first measurement data in a swing (also including a stop motion) of the user 2 or may perform the processes subsequent to step S20 after the processor 21 acquires some or all of a series of measurement data in the swing exercise of the user 2 from the sensor unit 10.

Next, the processor 21 detects a stop motion (address motion) (the motion of step S1 of FIG. 3) of the user 2 using the measurement data acquired from the sensor unit 10 (S20). When the processor 21 performs the process in real time and detects the stop motion (address motion), for example, the processor 21 may output a predetermined image or audio, or an LED may be provided in the sensor unit 10 and the LED may be turned on or off. Then, the user 2 is notified of detection of a stop state, and then the user 2 may start a swing after the user 2 confirms the notification.

Next, the processor 21 calculates the initial position and the initial posture of the sensor unit 10 using the measurement data (the measurement data in the stop motion (address motion) of the user 2) acquired from the sensor unit 10, the club specification information 242, the sensor-mounted position information 244, and the like (S30).

Next, the processor 21 detects the motions (for example, swing start, halfway-back, top, halfway-down, and impact) of the swing using the measurement data acquired from the sensor unit 10 (S40). A procedure example of the motion detection process will be described below.

The processor 21 calculates the position and the posture of the sensor unit 10 in the swing in parallel to, before, or after the process of step S40 using the measurement data acquired from the sensor unit 10 (S50).

Next, the processor 21 calculates the trajectory of the face coordinates P_{F} in the swing using the position and the posture of the sensor unit 10 in the swing, the club specification information 242, the sensor-mounted position information 244, and the like (S60).

Next, the processor 21 calculates a change in the square degree ξ in the swing (S70). An example of a calculation procedure of the change in the square degree ξ will be described below.

Next, the processor 21 generates image data indicating the trajectory of the face coordinates P_{F} and the change in the square degree ξ calculated in steps S60 and S70 and causes the displayer 25 to display the image data (S80), and then the process ends. An example of the procedure of the display process will be described below.

In the flowchart of FIG. 6, the sequence of the steps may be appropriately changed within a possible range.

### First Motion Detection Process

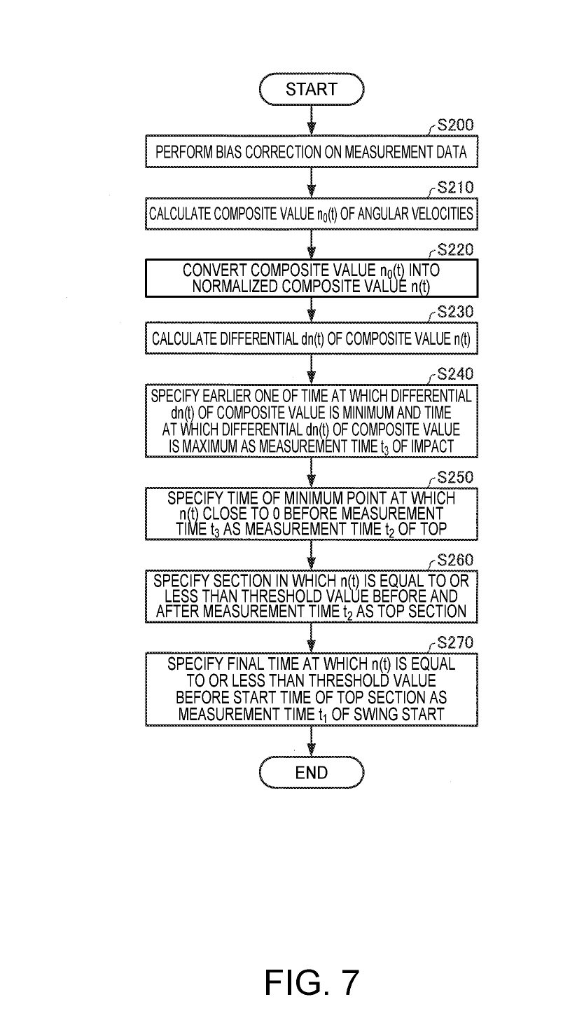

FIG. 7 is a flowchart illustrating an example of the procedure of a first motion detection process (a part of the process of step S40 in FIG. 6). A detection target of the first motion detection process is swing start, top, and impact. The first motion detection process corresponds to an operation of the processor 21 serving as the motion detector 211. Hereinafter, the flowchart of FIG. 7 will be described.

First, the processor 21 performs bias correction on the measurement data (the acceleration data and the angular velocity data) stored in the storage 24 (S200).

Next, the processor 21 calculates the value of a composite value n₀(t) of the angular velocities at each time t using the angular velocity data (the angular velocity data at each time t) subjected to the bias correction in step S200 (S210). For example, when the angular velocity data at time t are x(t), y(t), and z(t), the composite value n₀(t) of the angular velocities is calculated according to formula (1) below.

n₀(t)=\sqrt{x(t)²+y(t)²+z(t)²} (1)

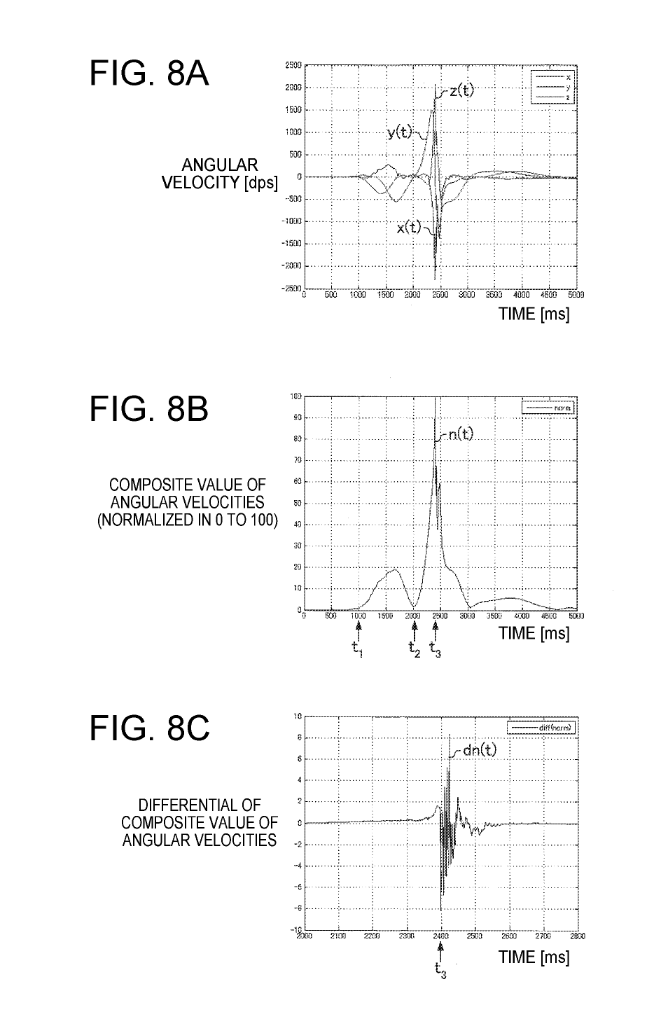

Examples of the triaxial angular velocity data x(t), y(t), and z (t) when the user 2 performs a swing and hits the golf ball 4 are illustrated in FIG. 8A. In FIG. 8A, the horizontal axis represents a time (msec) and the vertical axis represents an angular velocity (dps).

Next, the processor 21 converts the composite value n₀(t) of the angular velocities at each time t into a composite value n(t) normalized (subject to scale conversion) in a predetermined range (S220). For example, when max(n₀) is the maximum value of the composite value of the angular velocity during an acquisition period of the measurement data, the composite value n₀(t) of the angular velocities is converted into the composite value n(t) normalized in a range of 0 to 100 according to formula (2) below.

$$n ( t ) = \frac{100 \times {n}_{0} ( t )}{max ( {n}_{0} )} \qquad ( 2 )$$

FIG. 8B is a diagram illustrating a graph of the composite value n(t) normalized in 0 to 100 according to formula (2) after the composite value n₀(t) of triaxial angular velocities is calculated from the triaxial angular velocity data x(t), y(t), and z(t) in FIG. 8A according to formula (1). In FIG. 8B, the horizontal axis represents a time (msec) and the vertical axis represents a composite value of the angular velocities.

Next, the processor 21 calculates a differential dn(t) of the composite value n(t) after the normalization at each time t (S230). For example, when Δt is a measurement period of the triaxial angular velocity data, the differential (difference) dn(t) of the composite value of the angular velocities at time t is calculated according to formula (3) below.

dn(t)=n(t)−n(t−Δt) (3)

FIG. 8C is a diagram illustrating a graph by calculating the differential dn(t) from the composite value n(t) of the triaxial angular velocities in FIG. 8B according to formula (3). In FIG. 8C, the horizontal axis represents a time (msec) and the vertical axis represents a differential value of the composite value of the triaxial angular velocities. In FIGS. 8A and 8B, the horizontal axis is displayed from 0 seconds to 5 seconds. In FIG. 8C, however, the horizontal axis is displayed from 2 seconds to 2.8 seconds so that a change in the differential value before and after impact can be known.

Next, the processor 21 specifies, as measurement time t₃ of the impact, the earlier one of the time at which the value of the differential dn(t) of the composite value is the minimum and the time at which the value of the differential dn(t) of the composite value is the maximum (S240) (see FIG. 8C). In a normal golf swing, a swing speed is considered to be the maximum at the moment of impact. Since the value of the composite value of the angular velocities is considered to be also changed according to a swing speed, a timing at which the differential value of the composite value of the angular velocities during a series of swing motions is the maximum or the minimum (that is, a timing at which the differential value of the composite value of the angular velocities is the positive maximum value or the negative minimum value) can be captured as a timing of the impact. Since the golf club 3 is vibrated due to the impact, the timing at which the differential value of the composite value of the angular velocities is the maximum is considered to be paired with the timing at which the differential value of the composite value of the angular velocities is the minimum. The earlier timing between the timings is considered to be the moment of the impact.

Next, the processor 21 specifies the time of a minimum point at which the composite value n(t) is close to 0 before measurement time t₃ of the impact as measurement time t₂ of the top (S250) (see FIG. 8B). In a normal golf swing, it is considered that the motion temporarily stops at the top after the swing starts, and then the swing speed gradually increases and reaches the impact. Accordingly, a timing at which the composite value of the angular velocities before the timing of the impact is close to 0 and is the minimum can be captured as a timing of the top.

Next, the processor 21 specifies a section in which the composite value n(t) is equal to or less than a predetermined threshold value before or after measurement time t₂ of the top as a top section (S260). In a normal golf swing, the motion temporarily stops at the top. Therefore, the swing speed is considered to be small before or after the top. Accordingly, a section in which the composite value of the angular velocities is continuously equal to or less than the threshold value, including the timing of the top, can be captured as the top section.

Next, the processor 21 specifies the final time at which the composite value n(t) is equal to or less than a predetermined threshold value before the start time of the top section as measurement time t₁ of the swing start (S270) (see FIG. 8B), and then the process ends. In a normal golf swing, it is difficult to consider that a swing motion starts from a stop state and the swing motion stops until the top. Accordingly, a final timing at which the composite value of the angular velocities is equal to or less than the predetermined threshold value before the timing of the top can be captured as a start timing of a swing motion. A time of the minimum point at which the composite value n(t) is close to 0 before measurement time t₂ of the top may be specified as the measurement time of the swing start.

In the flowchart of FIG. 7, the sequence of the steps can be appropriately changed within a possible range. In the flowchart of FIG. 7, the processor 21 specifies the impact and the like using the triaxial angular velocity data, but can also specify the impact and the like similarly using the triaxial velocity data.

### Second Motion Detection Process

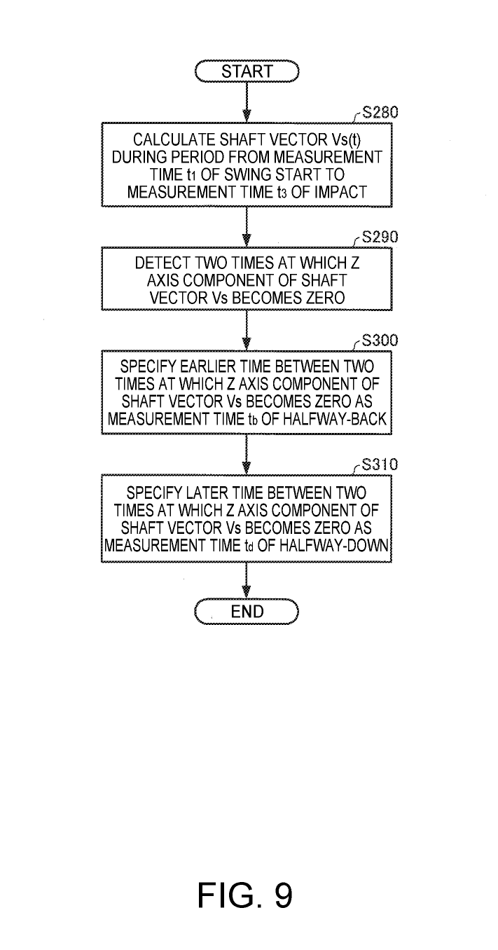

FIG. 9 is a flowchart illustrating an example of the procedure of a second motion detection process (a part of the process of step S40 in FIG. 6). A detection target of the second motion detection process is halfway-back and halfway-down. The second motion detection process corresponds to an operation of the processor 21 serving as the motion detector 211. Hereinafter, the flowchart of FIG. 9 will be described.

First, the processor 21 calculates a shaft vector V_{S}(t) at each time t during a predetermined time (time t₁ to time t₃) from measurement time t₁ of swing start to measurement time t₃ of impact (S280).

Next, the processor 21 detects two times at which the Z axis component of the shaft vector V_{S}(t) is zero during the predetermined time (time t₁ to time t₃) with reference to the Z axis component of the shaft vector V_{S}(t) at each time t (S290).

Next, the processor 21 specifies the earlier time between the two times as measurement time t_{b} of the halfway-back (S300).

The processor 21 specifies the later time between the two times as measurement time t_{d} of the halfway-down (S310) and ends the process.

The “halfway-back” mentioned here refers to a time point at which the shaft of the golf club 3 first becomes horizontal (parallel to the XY plane) after the swing start. The “halfway-down” mentioned here refers to a time point at which the shaft of the golf club 3 subsequently becomes horizontal after the halfway-back.

Accordingly, here, the time at which the Z axis component of the shaft vector V_{S}(t) first becomes zero is regarded as measurement time t_{b} of the halfway-back and the time at which the Z axis component subsequently becomes zero is regarded to as measurement time t_{d} of the halfway-down.

In the flowchart of FIG. 9, only the Z axis component of the shaft vector V_{S}(t) is used. Therefore, the calculation of the X axis component and the Y axis component of the shaft vector V_{S}(t) in step S280 can be omitted.

In the flowchart of FIG. 9, the Z axis component of the shaft vector V_{S}(t) is used to detect the time at which the shaft becomes horizontal. However, other indexes such as the components of some of the quaternions indicating the posture of the shaft may be used.

In the flowchart of FIG. 9, the sequence of the steps may be appropriately changed within a possible range.

### Process of Calculating Square Degree

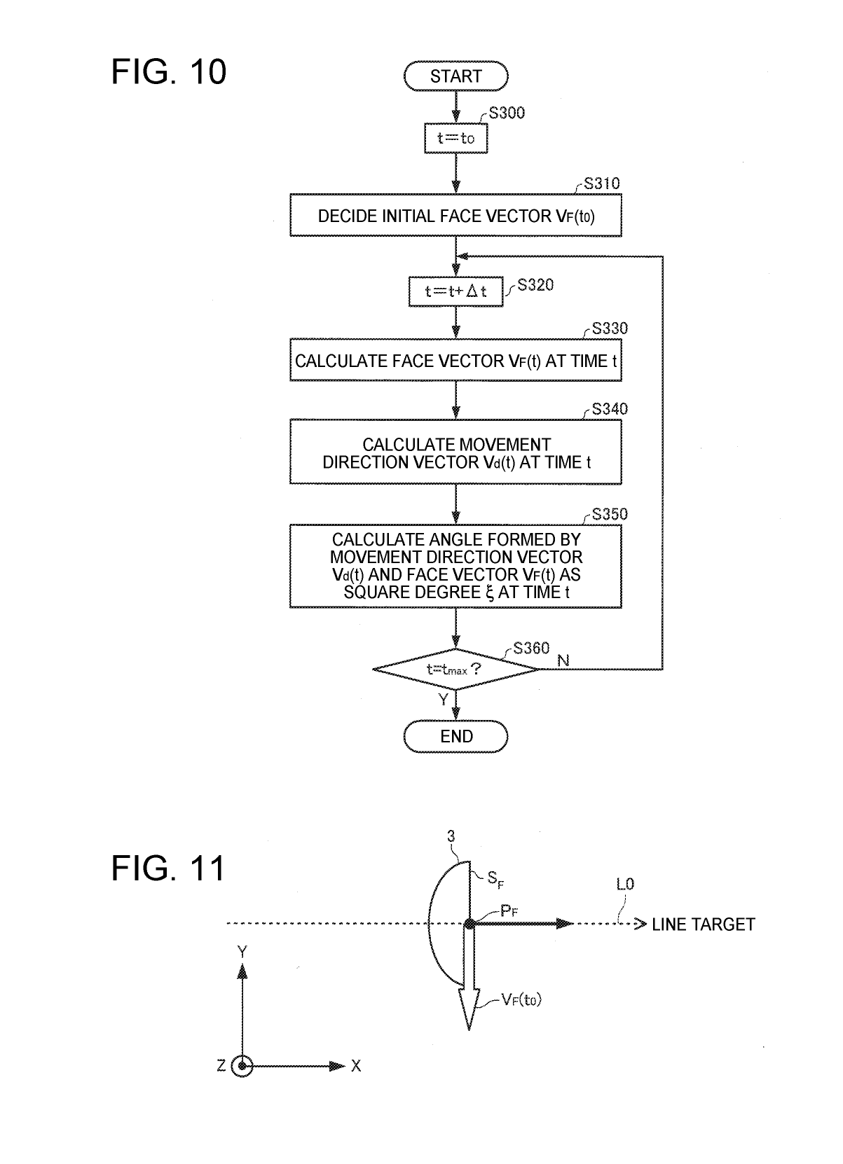

FIG. 10 is a flowchart illustrating an example of the procedure of the process of calculating a square degree (step 70 of FIG. 6). An operation of the processor 21 serving as the posture calculator 214 mainly corresponds to steps S310 and S330. The process of the processor 21 serving as the movement direction calculator 215 mainly corresponds step S340. Hereinafter, the flowchart of FIG. 10 will be described.

First, the processor 21 sets time t at which a calculation target is set as an initial value decided in advance. Here, measurement time t₀ of address is set to the initial value (S300).

Next, the processor 21 decides the face vector (initial face vector) V_{F}(t₀) at time t₀, as illustrated in FIG. 11. As described above, the X axis component and the Z axis component of the initial face vector V_{F}(t₀) are zero.

Next, the processor 21 increments time t at which the measurement target is set. Here, time t is assumed to increase by a measurement period Δt (S320).

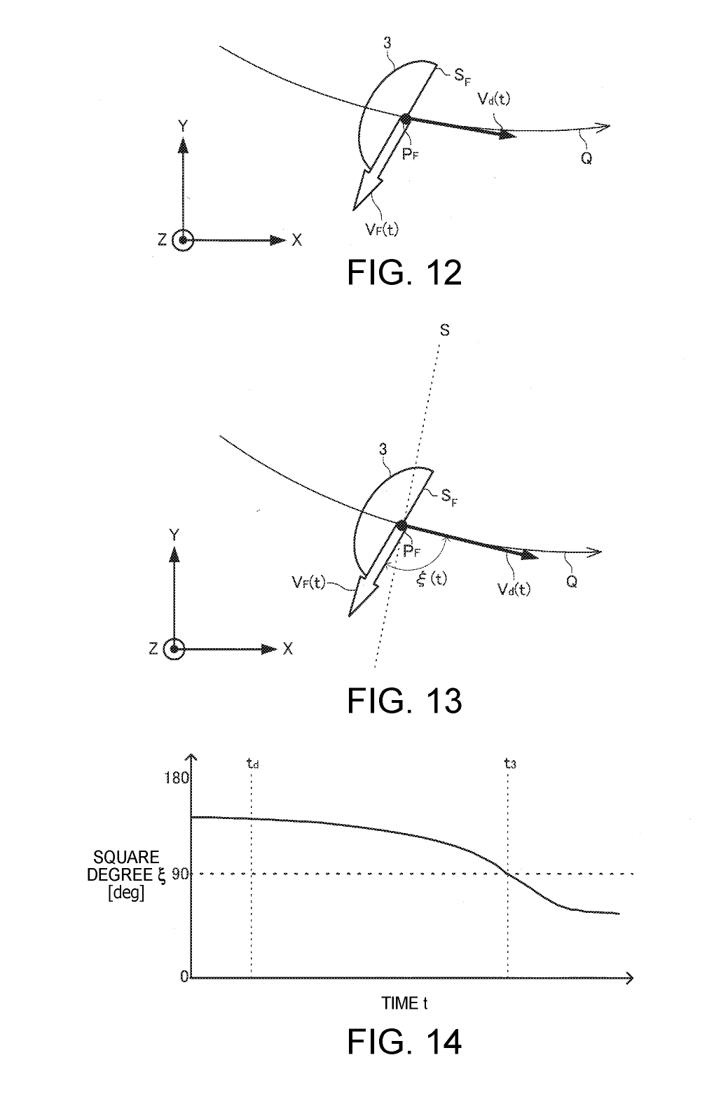

Next, as illustrated in FIG. 12, the processor 21 calculates the face vector V_{F}(t) at time t (S330). For example, the face vector V_{F}(t) at time t can be obtained from a face vector V_{F}(t−Δt) at time t(t−Δt) and posture change data of the face surface during a period from time (t−Δt) to time t.

Next, as illustrated in FIG. 12, the processor 21 calculates a movement direction vector V_{d}(t) at time t (S340). For example, the movement direction vector V_{d}(t) at time t is a unit vector oriented in the same direction as a vector that uses a face coordinate P_{F}(t−Δt) at time (t−Δt) as a starting point and uses face coordinates P_{F}(t) at time t as an ending point. The direction of the movement direction vector V_{d}(t) indicates a rough tangential direction of a trajectory Q of the face coordinates P_{F} at time t.

Next, as illustrated in FIG. 13, the processor 21 calculates an angle formed by the movement direction vector V_{d}(t) at time t and the face vector V_{F}(t) at time t as a square degree ξ(t) at time t (S350). The square degree ξ(t) at time t indicates a posture relation between the vertical surface (square surface S) of the trajectory Q at time t and the face surface S_{F} at time t.

To express the square degree (t) using a scalar amount, the size of a smaller angle than 180° among angles formed between the movement direction vector V_{d}(t) and the face vector V_{F} (t) in the XYZ space is set as the square degree ξ(t). In this case, when the posture of the face surface S_{F} with respect to the square surface S is so-called “open”, the square degree ξ(t) is greater than 90°. When the posture of the face surface S_{F} is so-called “square”, the square degree ξ(t) is 90°. When the posture of the face surface S_{F} is so-called “closed”, the square degree ξ(t) is less than 90°. The trajectory Q illustrated in FIG. 13 is a trajectory formed by the right-handed golf club 3. Even when the golf club 3 is a left-handed golf club, the values of the square degree ξ(t) corresponding to “open”, “square”, and “closed” are the same as those when the golf club 3 is a right-handed golf club.

Next, the processor 21 determines whether time t at which the calculation target is set reaches a maximum value tₘₐₓ (for example, a sufficiently large value than the length of the period of a swing including follow-through) decided in advance (S360). When time t does not reach the maximum value tₘₐₓ, the process proceeds to step (S320) of incrementing time t. When time t reaches the maximum value tₘₐₓ, the process ends.

In the flowchart of FIG. 10, the sequence of the steps may be appropriately changed within a possible range.

As the result of the above-described process, for example, the processor 21 can obtain the same data as data illustrated in FIG. 14.

A curve illustrated in FIG. 14 schematically indicates an example of a temporal change curve of the square degree in a swing. In FIG. 14, a value range of the horizontal axis (time axis) corresponds to a period from a downswing to follow-through. A line segment indicated by reference sign t_{d} indicates a measurement time of halfway-down and a line segment indicated by reference sign t₃ indicates a measurement time of impact.

As illustrated in FIG. 14, the value of the square degree ξ is maintained to be greater than 90° at the beginning of a downswing. However, the value gradually decreases as the downswing approaches impact. Thereafter, the square degree ξ(t) becomes 90° near the impact and is less than 90° at follow-through.

This means that the posture of the face surface S_{F} with respect to the trajectory approaches a square posture from an open posture during the downswing, becomes square near the impact, enters the follow-through, and then transfers to the closed posture.

The change curve illustrated in FIG. 14 is merely a schematic diagram. The behavior of the actual square degree ξ is various depending on habits or the like of the user 2.

### Square Degree Display Process

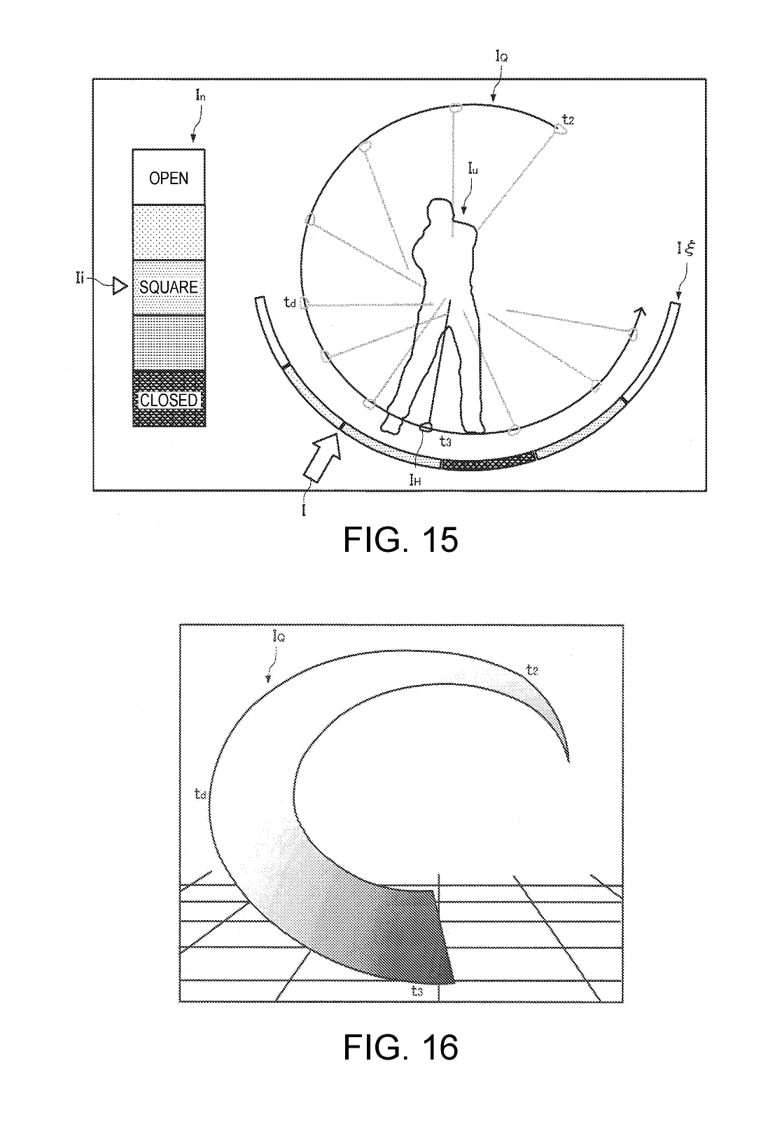

FIG. 15 is a diagram illustrating an example of a square degree display process. An example of the display process to be described here corresponds to an operation of the processor 21 serving as the display processor 217.

The processor 21 generates an image indicating a temporal change in the square degree ξ in a swing and displays the image on the displayer 25, for example, as illustrated in FIG. 15.

In the example illustrated in FIG. 15, a golfer image I_{U}, a trajectory image I_{Q} of the face surface, an orbicular graph Iξ indicating a temporal change in the square degree ξ, and an indicator Iₙ are disposed in the same screen.

The golfer image I_{U} is an image that resembles a golfer during a swing when viewed in a predetermined direction. In the example of FIG. 15, the shape of the golfer viewed on the front side is used as the golfer image I_{U}.

The trajectory image I_{Q} shows a curve indicating at least a part of the trajectory of the face surface. In the example of FIG. 15, a portion corresponding to a period (for example, a period from top to follow-through) before and after impact in the trajectory (a trajectory projected to the XZ plane) viewed on the front side of the golfer is used as the trajectory image I_{Q}.

The orbicular graph Iξ is a partial orbicular zone disposed along the trajectory image I_{Q} and indicates square degree ξ corresponding to each point (each face coordinate) forming a trajectory for each value range to which the square degree ξ belongs. The orbicular graph Iξ illustrated in FIG. 15 indicates a difference in the value range of ξ as a difference in a hatching pattern. Accordingly, the orbicular graph Iξ is divided into a plurality of blocks over a circumferential direction and mutually different hatching patterns are formed in the mutually adjacent blocks.

The indicator Iₙ corresponds to a legend of the orbicular graph Iξ and indicates which value range each of a plurality of kinds of hatching patterns used in the orbicular graph Iξ indicates. The indicator Iₙ illustrated in FIG. 15 indicates a correspondence relation between 5 kinds of hatching patterns and 5 kinds of value ranges. As the value range (open-side value range) is larger, the hatching pattern with lower density can be assigned.

The processor 21 according to the embodiment may display a change in the face coordinates during a swing and a change in the square degree ξ on the screen illustrated in FIG. 15 in an animation form.

For example, the processor 21 displays a motion (motion of the face surface) of a head I_{H} in the swing in an animation form and displays an indicator Iᵢ cooperated with the motion of the head I_{H} near the indicator Iₙ in an animation form. During the animation display, the indicator Iᵢ at each time point indicates the square degree ξ at each time point. In the example of FIG. 15, since the vertical direction of the indicator Iₙ corresponds to a ξ direction, the indicator Iᵢ is moved in the vertical direction during the animation display.

The processor 21 according to the embodiment may announce a timing at which the square degree ξ falls in the value range (a value range near 90°) corresponding to the square posture after start of a downswing (for example, after halfway-down) to the user.

The announcement of the timing may be performed by displaying an image such as an outline arrow, as indicated by reference sign I in FIG. 15 or may be performed by displaying screen reverse during the animation display. Alternatively, the announcement of the timing may be performed by outputting an audio (for example, a buzzer sound) during the animation display. The audio may be output via, for example, the audio output unit 26 described above.

In the example of FIG. 15, the difference in the square degree ξ is expressed by the difference in the hatching pattern. However, the difference in the square degree ξ may be expressed by a difference in color. Alternatively, the difference in the square degree ξ may be expressed by a difference in gray scale (brightness) or the difference in the square degree ξ may be indicated by a difference in a combination of color and gray scale.

When the difference in the square degree ξ is expressed by the difference in the color, it is desirable to assign more conspicuous color to a value range (a value range near 90°) corresponding to a square posture than another value range (for example, a value range corresponding to an open or closed posture).

In the example of FIG. 15, the difference in the square degree ξ may be indicated step by step, but may be indicated continuously. That is, the change in the square degree ξ may be displayed in a so-called gradation form.

### 1-4. Advantages

As described above, the processor 21 according to the embodiment calculates the change in the posture (the square degree ξ(t)) at each time t) of the face surface using a movement direction of the face surface in a swing as a criterion. Since the change in the posture (the square degree ξ(t)) has a strong influence on a projectile path, the change in the posture is considered to be effective in evaluation of a swing.

The processor 21 according to the embodiment expresses the change in the posture (the square degree ξ(t) at each time t) of the face surface by changing the hatching pattern, changing the color, or changing the gray scale. Therefore, the user can intuitively understand the change in the square degree in a swing.

The processor 21 according to the embodiment displays the change in the posture (the square degree ξ(t) at each time t) of the face surface along with the face coordinates (trajectory) at each time point. Therefore, the user can confirm the posture of the face surface at each check point (the top, the halfway-down, the impact, and the like) of a swing.

The processor 21 according to the embodiment announces the timing at which the posture of the face surface approaches the square posture to the user. Therefore, the user can also comprehend a relation between the posture of the face surface and a swing rhythm.

### 2. Modification Examples

The invention is not limited to the embodiment, but may be modified variously within the scope of the gist of the invention.

For example, the processor 21 according to the foregoing embodiment may display the image illustrated in FIG. 16 along with the example illustrated in FIG. 15 or instead of the example illustrated in FIG. 15.

In the example illustrated in FIG. 16, the trajectory image (the curved surface image with a belt shape) I_{Q} of the shaft viewed obliquely from the front side of the golfer is displayed and the same function as the orbicular graph is provided to the trajectory image I_{Q}. In the example illustrated in FIG. 16, the change in the square degree ξ is expressed with a continuous change in the gray scale (brightness).

For example, the contour of the trajectory image I_{Q} of the shaft illustrated in FIG. 16 can be obtained from a trajectory (a trajectory of the grip) of the position of the sensor unit and a trajectory (a trajectory of the head) of the position of the face surface.

The processor 21 according to the foregoing embodiment displays the temporal change in the square degree ξ as the orbicular graph or the like, but may display the change in the time of the square degree ξ as a two-dimensional graph illustrated in FIG. 14. In the example illustrated in FIG. 14, the image of a time change curve of the square degree ξ may be drawn on a two-dimensional graph that has a time axis and an angle axis, and an image of the line segment (a dashed line in FIG. 14) indicating the timing of the halfway-down and an image of the line segment (a dashed line in FIG. 14) indicating the timing of the impact are added.

The processor 21 according to the foregoing embodiment displays the trajectory image of the shaft or the face surface along with the temporal change in the square degree ξ. However, the displayed trajectory image may not be an actually measured image but an image (an image not measured actually) prepared in advance.

The processor 21 according to the foregoing embodiment sets the unit vector oriented in the same direction as the vector that uses the face coordinate P_{F}(t−Δt) at time (t−Δt) as a starting point and uses the face coordinates P_{F} (t) at time t as an ending point as the movement direction vector V_{d}(t) at time t. However, a unit vector oriented in the same direction as a vector that uses face coordinate P_{F}(t) at time t as a starting point and uses face coordinates P_{F}(t+Δt) at time (t+Δt) as an ending point may be set as the movement direction vector V_{d}(t).

Alternatively, a unit vector oriented in the same direction as a vector that uses face coordinate P_{F}(t−Δt) at time (t−Δt) as a starting point and uses face coordinates P_{F}(t+Δt) at time (t+Δt) as an ending point may be set as the movement direction vector V_{d}(t).

Alternatively, the processor 21 according to the foregoing embodiment may calculate the movement direction vector V_{d}(t) in, for example, steps (1) to (3) below.

(1) A trajectory Q of the face coordinates P_{F} during a given period including times before and after time t is calculated.

(2) A tangential line of the trajectory Q at time t is calculated.

(3) A unit vector oriented in the same direction as the direction of the tangential line is set as the movement direction vector V(t).

The processor 21 according to the foregoing embodiment performs the process of calculating and displaying the square degree ξ as the process after the swing, but may perform this process as a real-time process in a swing.

The processor 21 according to the foregoing embodiment displays the measurement result of the square degree ξ as the image (including the graph and the animation), but may display the measurement result as a numerical value.

The processor 21 according to the foregoing embodiment uses the angle formed between the movement direction vector and the face vector in the space (the XYZ space) as the index that indicates the posture of the face surface using the movement direction of the face surface as the criterion. An angle formed between the movement direction vector and the face vector on a predetermined plane (that is, an angle formed by the movement direction vector projected to the predetermined plane and the face vector projected to the predetermined plane) may be used.

The predetermined plane to which these vectors are projected is, for example, a predetermined plane intersecting in the vertical direction. For example, an approximate plane of a curved surface including the movement direction of the head (or the face surface), a horizontal plane (the XY pane), or the like can be used.

The processor 21 according to the foregoing embodiment uses the angle between the movement direction vector and the face vector as the index that indicates the posture of the face surface using the movement direction of the face surface as the criterion. Another index, e.g., a difference vector between the movement direction vector and the face vector, may be used.

The processor 21 according to the foregoing embodiment uses the unit vector (which is an example of a predetermined vector formed along the hitting surface) oriented in the −Y axis direction at time t₀ as the face vector. Another vector fixed to the face surface may be used as the face vector. For example, the unit vector (which is an example of a predetermined vector intersecting the hitting surface) oriented in the +X axis direction at time t₀ may be used as the face vector.

Alternatively, when the posture of the face surface at time t₀ is known from the club specification information 242 and the sensor-mounted position information 244, a normal vector (which is an example of a predetermined vector intersecting the hitting surface) of the face surface may be used as the face vector.

The processor 21 according to the foregoing embodiment mainly adopts the image as the announcement form of the measurement result. For example, another announcement form such as a temporal change pattern of light intensity, a temporal change pattern of color, a change pattern of audio intensity, a change pattern of an audio frequency, or a rhythm pattern of vibration may be adopted.

In the foregoing embodiment, some or all of the functions of the processor 21 may be mounted on the side of the sensor unit 10. Some of the functions of the sensor unit 10 may be mounted on the side of the processor 21.

In the foregoing embodiment, some or all of the processes of the processor 21 may be performed by an external device (a tablet PC, a laptop PC, a desktop PC, a smartphone, or a network server) of the swing analysis device 20.

In the foregoing embodiment, some or all of the acquired data may be transferred (uploaded) to an external device such as a network server by the swing analysis device 20. The user may browse or download the uploaded data on or to the swing analysis device 20 or an external device (a personal computer, a smartphone, or the like), as necessary.

The swing analysis device 20 may be another portable information device such as a head-mounted display (HMD) or a smartphone.

In the foregoing embodiment, the sensor unit 10 is mounted on the grip of the golf club 3, but may be mounted on another portion of the golf club 3.

In the foregoing embodiment, each motion is detected in a swing of the user 2 using a square root of a sum of the squares expressed in formula (1) as the composite value of the triaxial angular velocities measured by the sensor unit 10. However, besides the composite value of triaxial angular velocities, for example, a sum of the squares of the triaxial angular velocities, a sum or an average value of the triaxial angular velocities, or a product of the triaxial angular velocities may be used as the composite value of the triaxial angular velocities. Instead of the composite value of the triaxial angular velocities, a composite value of triaxial accelerations, such as a sum of squares of the triaxial accelerations, a square root of the sum of the squares of the triaxial accelerations, a sum or an average value of the triaxial accelerations, or a product of the triaxial accelerations may be used.

In the foregoing embodiment, the acceleration sensor 12 and the angular velocity sensor 14 are built to be integrated in the sensor unit 10. However, the acceleration sensor 12 and the angular velocity sensor 14 may not be integrated. Alternatively, the acceleration sensor 12 and the angular velocity sensor 14 may not be built in the sensor unit 10, but may be directly mounted on the golf club 3 or the user 2. In the foregoing embodiment, the sensor unit 10 and the swing analysis device 20 are separated from each other. The sensor unit 10 and the swing analysis device 20 may be integrated to be mounted on the golf club 3 or the user 2.

In the foregoing embodiment, the swing analysis system (swing analysis device) that analyzes a golf swing has been described as an example. However, the invention can be applied to a swing analysis system (swing analysis device) analyzing swings of various exercises such as tennis, baseball, and the like.

The foregoing embodiments and modification examples are merely examples, but the invention is not limited thereto. For example, the embodiments and the modification examples can also be appropriately combined.

The invention includes configurations (for example, configurations in which functions, methods, and results are the same or configurations in which objects and advantages are the same) which are substantially the same as the configurations described in the embodiments. The invention includes configurations in which non-essential portions of the configurations described in the embodiments are substituted. The invention includes configurations in which the same operational advantages as the configurations described in the embodiments are obtained or configurations in which the same objects can be achieved. The invention includes configurations in which known technologies are added to the configurations described in the embodiments.

The entire disclosure of Japanese Patent Application No. 2014-258534, filed Dec. 22, 2014 is expressly incorporated by reference herein.

What is claimed is:

1. An exercise analysis device comprising:
a calculator that obtains a change in a relation between a movement direction of a hitting surface of an exercise tool and a posture of the hitting surface during an exercise by using an output of an inertial sensor.

2. The exercise analysis device according to claim 1,
wherein the calculator obtains an angle formed by a vector indicating a movement direction of the hitting surface and a predetermined vector along the hitting surface as the relation.

3. The exercise analysis device according to claim 1,
wherein the calculator obtains an angle formed by a vector indicating a movement direction of the hitting surface and a predetermined vector intersecting the hitting surface as the relation.

4. The exercise analysis device according to claim 1, further comprising:
an output processor that outputs the change in the relation.

5. The exercise analysis device according to claim 4,
wherein the output processor displays the change in the relation as a change in color.

6. The exercise analysis device according to claim 5,
wherein the output processor assigns and displays color decided in advance for each range to which the relation belongs.

7. The exercise analysis device according to claim 4,
wherein the output processor displays the change in the relation along with trajectory information regarding the exercise tool during the exercise.

8. The exercise analysis device according to claim 5,
wherein the output processor displays the change in the relation along with trajectory information regarding the exercise tool during the exercise.

9. The exercise analysis device according to claim 4,
wherein the output processor outputs a timing at which the relation falls in a predetermined range.

10. The exercise analysis device according to claim 5,
wherein the output processor outputs a timing at which the relation falls in a predetermined range.

11. The exercise analysis device according to claim 8,
wherein the output processor outputs a timing at which the relation falls in a predetermined range.

12. An exercise analysis system comprising:
the exercise analysis device according to claim 1; and
an inertial sensor.

13. An exercise analysis system comprising:
the exercise analysis device according to claim 2; and
an inertial sensor.

14. An exercise analysis system comprising:
the exercise analysis device according to claim 3; and
an inertial sensor.

15. A display device displaying a change in a relation between a movement direction of a hitting surface of an exercise tool and a posture of the hitting surface during an exercise by using an output of an inertial sensor.

16. The display device according to claim 15,
wherein the change is displayed with a gray scale.

17. An exercise analysis method comprising:
obtaining a change in a relation between a movement direction of a hitting surface of an exercise tool and a posture of the hitting surface during an exercise by using an output of an inertial sensor.

18. A recording medium that records an exercise analysis program causing a computer to perform:
obtaining a change in a relation between a movement direction of a hitting surface of an exercise tool and a posture of the hitting surface during an exercise by using an output of an inertial sensor.
